(19) United States
(12) Patent Application Publication
(10) Pub. No.: US 2022/0193665 A1
(43) Pub. Date: Jun. 23, 2022

(54) ORGANIZING RACK FOR POOL TESTING

(71) Applicant: Lauren M. Siegel, Austin, TX (US)

(72) Inventor: Lauren M. Siegel, Austin, TX (US)

(21) Appl. No.: 17/554,989

(22) Filed: Dec. 17, 2021

Related U.S. Application Data
(60) Provisional application No. 63/130,166, filed on Dec. 23, 2020.

(51) Int. Cl. B01L 3/00; B01L 9/00

(52) U.S. Cl. CPC B01L 3/50855; B01L 3/545; B01L 9/523; B01L 2300/12; B01L 2300/0864; B01L 2300/0832; B01L 2300/021; B01L 2300/0829

(57) ABSTRACT

An organizing rack for pooled testing of test samples, as well as a kit for the same, and methods of their use are disclosed. Organizing racks may be used to assist with the creation and testing of specifically organized test sample pools which may be used to minimize the number of tests required to screen a plurality of test samples. Multiple organizing racks may be used in a matrix-based fashion to further reduce the number of tests required to screen a large number of test samples.

### PRIORITY STATEMENT UNDER 35 U.S.C. § 119 & 37 C.F.R. § 1.78

This non-provisional application claims priority based upon prior U.S. Provisional Patent Application Ser. No. 63/130,166 filed Dec. 23, 2020, in the name of Lauren Siegel entitled “ORGANIZING RACK FOR POOL TESTING,” the disclosures of which are incorporated herein in their entirety by reference as if fully set forth herein.

### BACKGROUND OF THE INVENTION

Pooled testing conserves lab reagents and uses less machine time to deliver test results. The ways samples are combined can vary following different mathematical structures to maximize results and minimize errors. The resulting increase in production can address surge demand on laboratory services, or it can be used to scale up capacity to test a much larger part of the population as part of a surveillance effort.

In the U.S., most laboratories do not use pooled testing. There are difficulties in executing the pools when a multistep process is selected, and when there are humans executing the pools. Tracking the samples and tracking the pools that go into the PCR machine, and then taking the resulting positive pools and getting the results by identifying infected samples adds a level of complexity that the labs cannot handle.

Adaptive pooling is particularly problematic because it requires the testing of several groups, and then when a group has been identified as containing a positive, new subgroups of the positive are formed for re-testing, or testing is done on all individuals in that group using more resources and time.

Non-adaptive pooling creates several kinds of pools that can deliver a result in one round of PCR testing that not only shows that a pool or group contains an infection, but which individual from the original sample set has the infection.

### SUMMARY OF THE INVENTION

Embodiments of the present invention relate generally to apparatuses, methods, and systems for pool testing. More specifically those embodiments relate to a way to organize and execute a matrix pooling scheme that facilitates sample preparation and makes it easy to determine results, and to apparatuses that may be used to facilitate said matrix pooling scheme.

The organizing racks described herein provide for several desired outcomes. 1) They organize and clearly indicate to a user of the organizing rack how to transfer portions of the test samples, in a straight path from sample wells to both index pool wells and trigger pool wells without crossing over the path of any other test sample. 2) They allow for screening of a multiple pooled test samples without the need for testing each test sample individually. 3) They allow for a matrix-style use of multiple organizing racks to even further reduce the number of tests required to screen a large number of test samples. Additionally, the organizing rack kit discussed herein, allows for the easy and efficient production, shipping, and assembly of organizing racks, such as those taught herein.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 provides a schematic depiction of the front and back of an exemplary embodiment of an organizing rack that facilitates the pooling of twelve samples into eight pools.

FIG. 2 provides a schematic depiction of an exemplary embodiment of an organizing rack, as shown in FIG. 1, showing the location of test samples A-L during its use as described in accordance with Use 1.

FIG. 3 provides a schematic depiction showing three organizing racks and an index pool column insert, in accordance with embodiments.

FIG. 4 provides a schematic depiction of an exemplary embodiment of three organizing racks and an index pool column insert, as shown in FIG. 3, showing the location of test samples A-J′ during their use as described in accordance with Use 2.

FIG. 5 shows an exemplary organizing rack with PCR-type tubes retained in many of the wells of the organizing rack, in accordance with embodiments.

FIG. 6 shows a schematic depiction of an exemplary embodiment of an organizing rack kit, in accordance with embodiments.

FIG. 7 shows a block diagram of a method for using an organizing rack for pooled testing of test samples, in accordance with embodiments.

FIG. 8 shows a flow diagram of a method of determining a positive result using an organizing rack for pooled testing of test samples, in accordance with embodiments.

### DESCRIPTION OF THE INVENTION

The present invention is directed to improved apparatuses, methods, and systems for pooled testing. The configuration and use of the presently preferred embodiments are discussed in detail below. It should be appreciated, however, that the present invention provides many applicable inventive concepts that can be embodied in a wide variety of contexts other than pool testing. Accordingly, the specific embodiments discussed are merely illustrative of specific ways to make and use the invention, and do not limit the scope of the invention. In addition, the following terms shall have the associated meaning when used herein:

“Well” means an aperture in an organizing rack, configured to receive and retain either 1) a test sample and/or a mixture of test samples, or 2) a container, such as a PCR-type tube, which itself may be used to contain a test sample and/or a mixture of test samples.

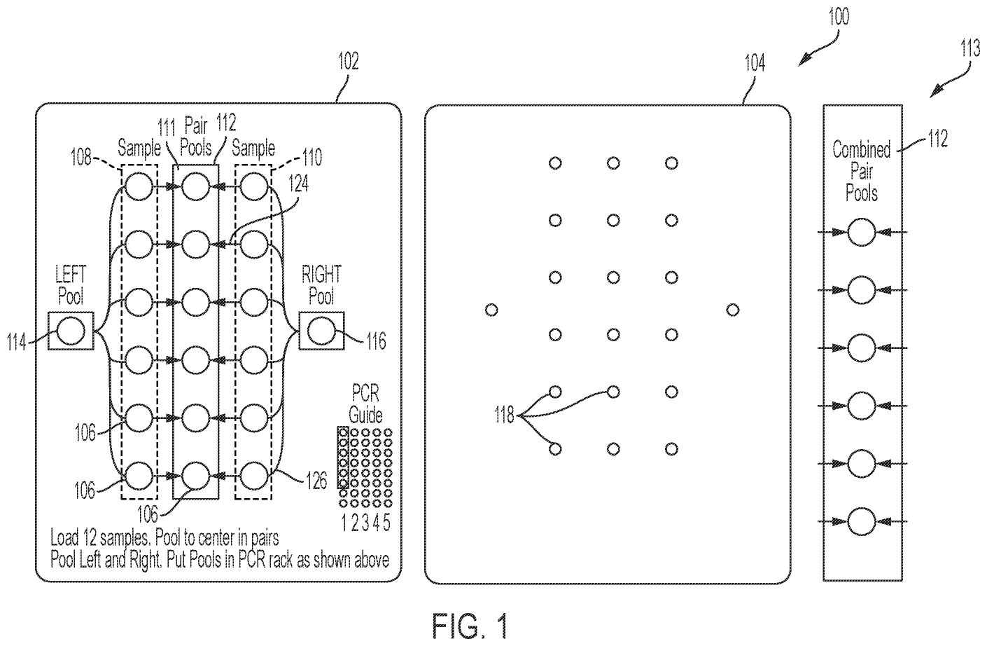

FIG. 1 shows a front and back views of an exemplary embodiment of an organizing rack, specifically organizing rack 100, that facilitates the pooling of twelve test samples into eight pools (six index pool wells and two trigger pools). Organizing rack 100 comprises a top surface 102 having plurality of wells 106, organized into three columns, test sample column 108, test sample column 110, and index pool column 112 with each of columns 108, 110, and 112 comprising a line of wells; two trigger pool wells 114 and 116; and a bottom surface 104 having a plurality of holes 118.

Embodiments of organizing racks may comprise any number of sample wells split evenly between the two test columns. In such embodiments, the number of wells in the index pool column will be equal to the number of wells in each of the two test sample columns (i.e., half of the total number of sample wells).

In the embodiment of an organizing rack depicted in FIG. 1, organizing rack 100, each of test sample column 108, test sample column 110, and index pool column 112 comprise six wells. Accordingly, organizing rack 100 is capable of being used to test a total of twelve test samples (six in sample column 108 and six in sample column 110), therefore organizing rack 100 would be considered a “twelve-sample organizing rack”. A twelve-sample organizing rack, like organizing rack 100, also comprises eight additional pooling wells in which the test samples may be pooled, consisting of the six index pool wells from index pool column 112 and trigger pool wells 114 and 116. Accordingly, in addition to being a “twelve-sample organizing rack”, rack 100 may be considered an “eight-pool organizing rack.”.

In embodiments, the total number of pooling wells will equal half the total number of test sample wells plus two. Another way of saying this is that the total number of pooling wells in an organizing rack will equal the number of rows of wells formed by columns 108, 110, and 112, plus two. Accordingly, an organizing rack having twelve test sample wells will have eight pooling wells consisting of six index pool wells and two trigger pool wells, while an organizing rack having sixteen test sample wells will have ten pooling wells consisting of eight index pool wells and two trigger pool wells, and organizing rack having ten test sample wells will have seven pooling wells consisting of five index pool wells and two trigger pool wells, etc.

Test sample column 108 and test sample column 110 may be located on opposite sides of index pool column 112, and the wells comprising each of test sample column 108, test sample column 110, and index pool column 112 may be positioned such that they form rows running across the three columns 108, 110, and 112. Trigger pool wells 114 and 116 may each be located on opposite sides of the three columns 108, 110, and 112.

In embodiments, top surface 102 may comprise a plurality of markings, such as markings 124, which may connect each of a n^{th} well of test sample column 108 and a n^{th} well of test sample column 110 to a n^{th} well of index pool column 112, and which may indicate directionality going from each of the test sample column wells to the index pool column well; and group markings 126, which may connect each of trigger pool wells 114 and 116 to each of the wells of test sample columns 108 and 110 on their respective sides of index pool column 112.

In embodiments, wells, such as wells 106, may be formed by an aperture in top surface 102 of organizing rack 100. In embodiments, holes 118 in the bottom surface 104 of organizing rack 100 may each be associated with a well 106 in front surface 102 of organizing rack 100, and in fluid communication therewith. In embodiments, holes 118 may be smaller than their corresponding wells 106, and together wells 106 and holes 118 may be sized and otherwise configured to receive and retain PCR tubes.

Organizing rack 100 may be used to facilitate the pooling of twelve test samples into eight pools. Embodiments of organizing racks comprising eight pooling wells, like organizing rack 100, may be preferred as such embodiments may facilitate operator accuracy when transcribing samples and maximize use of available space by using all the vial spots in a standard PCR machine. In such embodiments, the mixed test samples from the organizing rack's eight pooling wells may be easily oriented, in groups of eight, into the eight-well columns of a standard 8×12 PCR rack.

Use 1—Guided Non-Adaptive Paired Pooling with One Step to Results.

To use an organizing rack, such as organizing rack 100, for non-adaptive paired pooling, a user may put each of a dozen test samples into their respective test sample wells of test sample columns 108 and 110. The user may then mix a portion of each of the test samples from test sample column 108 together in trigger pool well 114 and may similarly mix a portion of each of the test samples from test sample column 110 in trigger pool well 116.

A user may also mix a portion of a test sample from a well of test sample column 108 with the test sample from the well of test sample column 110 in the same row as the corresponding test sample selected from test sample column 108. These paired test samples may be mixed in the well of index pool column 112 corresponding to the row form which said test samples were selected. This may be repeated for each row in organizing rack 100 until each test sample from the wells of test sample column 108 has been mixed with its associated test sample from the corresponding wells of test sample column 110.

At this point each of trigger pool wells 114 and 116 should contain portions of six different test samples, none of which should be in both trigger pool wells 114 and 116; and each of the wells of index pool column 112 should contain portions of two different test samples, specifically a sample from each of the wells of test sample columns 108 and 110 located in the same row as said index pool column well. No two of the index pool column wells should contain a portion of the same test sample. Once this has been completed, each of the paired test sample mixes from the wells of index pool column 112 and the mixes from trigger pool wells 114 and 116 may be tested by means known in the art.

If there is one positive result in the six index pool wells of index pool column 112, there must also be at least one positive result in one of trigger pools 114 or 116, which allows for unique identification of the positive sample by identifying the lone test sample which was included in both the index pool well and said trigger pool well that tested positive. Based on the layout of organizing rack 100 the positive test sample would be the one that was placed in the test sample well of the test sample column located on the same side of the index pool column as the trigger pool that tested positive, and in the row corresponding to the index pool well that tested positive.

In this way a user may reduce the number of tests required to screen twelve test samples by performing only eight tests, whereas when testing without such pooling twelve tests would have been needed to screen said twelve test samples.

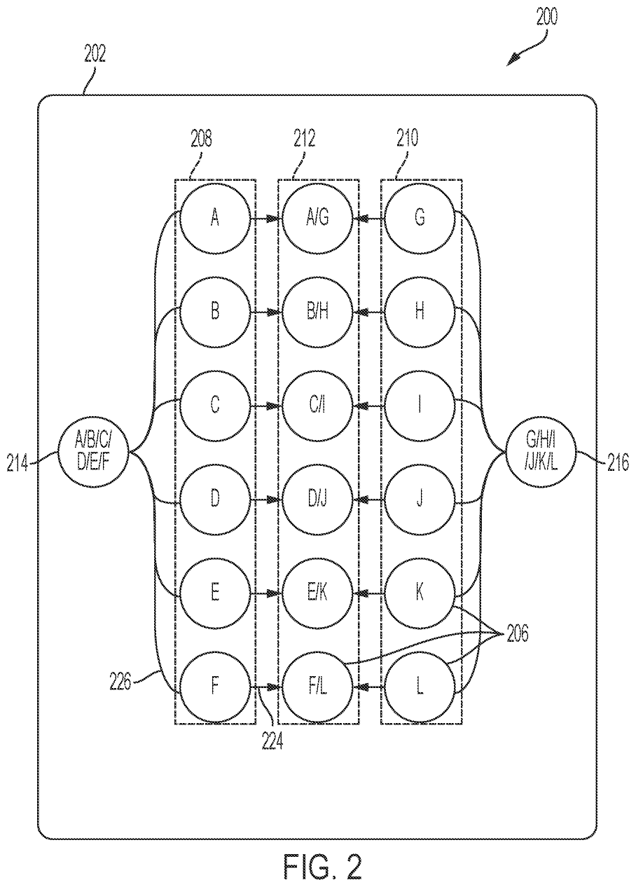

FIG. 2 illustrates how exemplary test samples A-L may be distributed across the wells of an organizing rack, namely organizing rack 200, after mixing, as discussed in Use 1. This depiction of organizing rack 200, shows how all test samples from test sample column 208 (test samples A, B, C, D, E, and F) may be mixed in trigger pool well 214; and, similarly, how all test samples from test sample column 210 (test samples G, H, I, J, K, and L) may be mixed trigger pool well 216. It also shows how each of the wells of index pool column 212 may receive a mix of the test samples from the corresponding row of each of test sample columns 208 and 210, which, according to the example shown in FIG. 2 means that test samples A and G would be mixed in the first well of index pool column 212, test samples B and H would be mixed in the second well of index pool column 212, test samples C and I would be mixed in the third wells of index pool column 212, test samples D and J would be mixed in the fourth well of index pool column 212, test samples E and K would be mixed in the fifth well of index pool column 212, and test samples F and L would be mixed in the sixth well of index pool column 212.

If, for example, after testing a positive result is returned for both trigger pool well 214 (containing test samples A, B, C, D, E, and F) and for the fourth well of index pool column 212 (containing test samples D and J), it can easily be determined that test sample D must be the positive test sample, as it is the only test sample that is present in both mixes that tested positive.

Similarly, testing showed trigger pool wells 216 (containing test samples G, H, I, J, K, and L) along with the fourth well of index pool column 212 (containing test samples D and J) as being positive, then it could be determined that test sample J was the positive test sample, as it is the only test sample that is present in both mixes that tested positive.

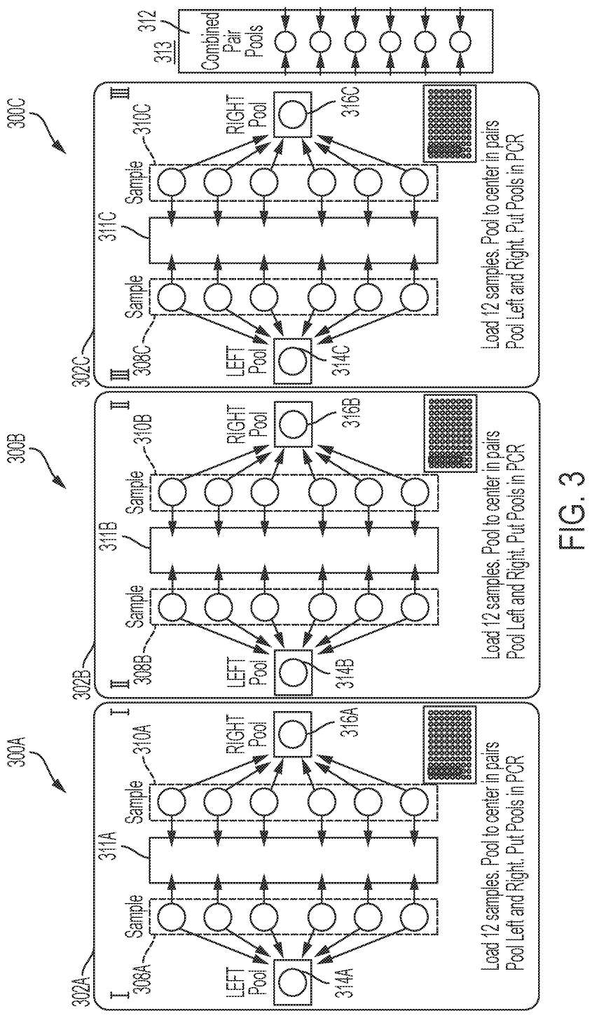

FIG. 3 shows a front and back views of exemplary embodiments of organizing racks, namely, organizing racks 300A, 300B, and 300C, each of which may facilitate the pooling of twelve test samples into eight pooled wells. Organizing racks 300A, 300B, and 300C each comprise a top surface 302 having plurality of wells 306, organized into three columns, test sample column 308, test sample column 310, and index pool column 312, with each of columns 308, 310, and 312 comprising a line of wells, and two trigger pool wells 314 and 316, and a bottom surface 304 having a plurality of holes 318.

In embodiments, organizing racks may comprise a slot, such as slot 311A in organizing rack 300A and an insert 313 configured to be removably inserted into slot 311A. In embodiments insert 313 may comprise index pool column 312. Insert 313 may be configured to be transferred between, and interchangeably inserted into, such a corresponding slot of any organizing rack. For example, insert 313 comprising index pool column 312 may be able to be removed slot 311A of organizing rack 300A and inserted into either slot 311B or slot 311C of organizing racks 300B and 300C, respectively.

Use 2, discussed below shows that a plurality of organizing racks may be used together in a matrix-type fashion to further improve the ratio of tests required to screen test samples.

### Use 2—Combining to Form More Efficient Matrix Pooling—One Step to Results

In one embodiment, after filling the index pool wells of index pool column 312 on insert 313 while it is retained in slot 311A of organizing rack 300A with mixes of the test samples from test sample columns 308A and 310A as discussed regarding organizing rack 100 of FIG. 1 in Use 1 above. Similarly, as discussed hereinabove in Use 1, the test samples from test sample column 308A may be combined in trigger pool well 314A, and the test samples from test sample column 310A may be combined in trigger pool well 316A. Once this has been completed, insert 313 may then be removed from slot 311A of organizing rack 300A and inserted into slot 311B of organizing rack 300B.

The test samples located in organizing rack 300B may then be added to the index pool wells of index pool column 312 on insert 313 in a similar fashion those as was done with the test samples from test sample columns 308A and 310A from organizing rack 300A, bringing the total number of test samples in each of the index pool wells of index pool column 312 to four (one from corresponding rows from each of test sample columns 308A, 310A, 308B, and 310B). The test samples from test sample column 308B may be combined in trigger pool well 314B, and the test samples from test sample column 310B may be combined in trigger pool well 316B. Once this has been completed, insert 313 may then be removed from slot 311B of organizing rack 300B and inserted into slot 311C of organizing rack 300C.

The twelve test samples located in organizing rack 300C may then be added to the index pool wells of index pool column 312 on insert 313 in a similar fashion those as was done with the test samples from test sample columns 308A and 310A from organizing rack 300A and test sample columns 308B and 310B from organizing rack 300B, bringing the total number of test samples in each of the index pool wells of index pool column 312 to six (one from corresponding rows from each of test sample columns 308A, 310A, 308B, 310B, 308C, and 310C). The test samples from test sample column 308C may be combined in trigger pool well 314C, and the test samples from test sample column 310C may be combined in trigger pool well 316C.

In this method, while the index pool wells of index pool column 312 on insert 313 each gain two test samples from each of organizing racks 300A, 300B, and 300C, while the two trigger pool wells 314 and 316 of each organizing rack 300A, 300B, and 300C contain only test samples from the test samples columns and from their respective organizing racks.

The matrix method of using organizing racks for pooled testing shown in Use 2, when iterated across eight sets of three matrixed twelve-test sample organizing racks, may allow for 288 samples to be tested using a total of total 96 tests. When one positive result exists for each of the eight sets of three matrixed twelve-test sample organizing rack groups, no additional tests are needed. Additionally, when processed in this manner, one twelve-test sample organizing rack delivering multiple positive results will not impact the results in the other seven sets of three matrixed twelve-test sample organizing racks processed in that same run.

The method discussed in Use 2, using three eight-pool organizing racks, resulting in a total of twelve mixed samples for testing (the samples from trigger pool wells 314A, 316A, 314B, 316B, 314C, and 316C, and the six samples from index pool column 312 on insert 313) may be a preferred use case, as it may be optimized for the standard 8×12 PCR racks.

If there is one positive result in the six combined index pools of index pool column 312, there must also be one positive result in the six trigger pool wells 314A, 316A, 314B, 316B, 314C, and 316C, which allows for immediate unique identification of the positive sample based on the identification of the lone test sample present in the two pooled wells that tested positive.

If testing results in an ambiguous result, such as if multiple index pool wells test positive and multiple trigger pool wells test positive, then a user may identify the test samples that require supplemental testing to determine with certainty which test samples may be positive. In such instances the test samples that would require such supplemental testing would be the test samples corresponding to both the multiple positive index pool wells and the multiple positive trigger pool wells.

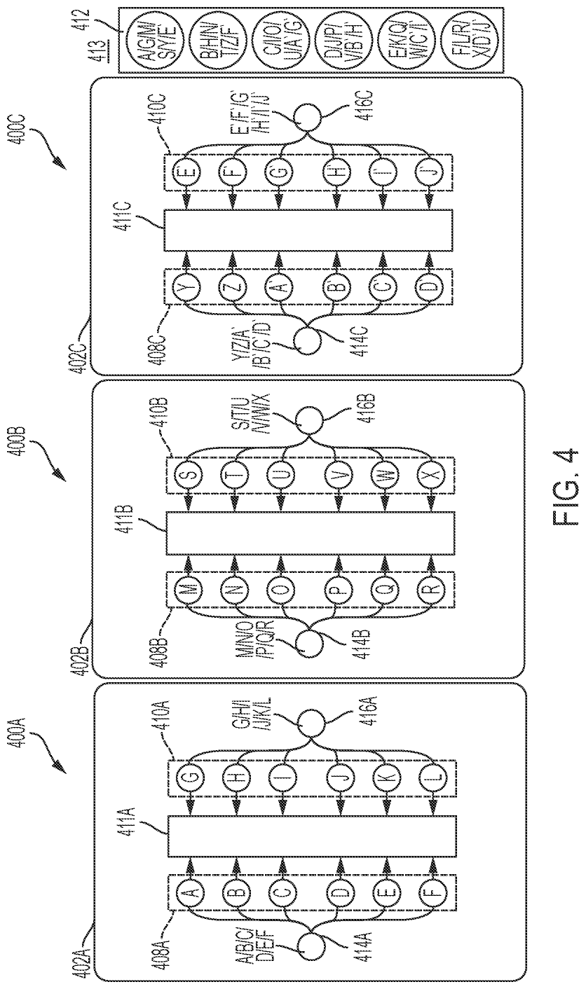

FIG. 4 illustrates how exemplary test samples A-J′ may be distributed across the wells a trio of organizing racks, namely organizing racks 400A, 400B, and 400C, and insert 413 comprising index pool column 412, after mixing, as discussed in Use 2. This depiction of organizing racks 400A, 400B, and 400C shows how all test samples from test sample column 408A (test samples A, B, C, D, E, and F) may be mixed in trigger pool well 414A; and, similarly, how all test samples form test sample column 410A (test samples G, H, I, J, K, and L) may be mixed in trigger pool well 416A. Similarly, all test samples from test sample column 408b (test samples M, N, O, P, Q, and R) may be mixed in trigger pool well 414B, all test samples from sample column 410B (test samples S, T, U, V, W, and X) may be mixed in trigger pool well 416B, all test samples from test sample column 408C (test samples Y, Z, A′, B′, C′, and D′) may be mixed in trigger pool well 414C, and all test samples from test sample column 410C (test samples E′, F′, G′, H′, I; and J) may be mixed in trigger pool well 416C.

FIG. 4 also shows how each of the wells of index pool column 412, which may be located on insert 413, may receive a mix of the test samples from the corresponding row of each of test sample columns 408A, 410A, 408B, 410B, 408C, and 410C; which, according to the example shown in FIG. 3 means that test samples A, G, M, S, Y, and E′ would be mixed in the first well of index pool column 412, test samples B, H, N, T, Z, and F′ would be mixed in the second well of index pool column 412, test samples C, I, O, U, A′, and F′ would be mixed in the third wells of index pool column 412, test samples D, J, P, V, B′, and H′ would be mixed in the fourth well of index pool column 412, test samples E, K, Q, W, C′, and I′ would be mixed in the fifth well of index pool column 412, and test samples F, L, R, X, D′ and J′ would be mixed in the sixth well of index pool column 412.

If, for example, after testing a positive result is returned for both trigger pool well 414B (containing test samples M, N, O, P, Q, and R) and for the fourth well of index pool column 412 (containing test samples D, J, P, V, B′, and H′), it could be determined that test sample P must be the positive test sample, as it is the only test sample that is present in the test sample mixes from both pooled wells that tested positive.

Similarly, testing showed trigger pool well 416C (containing test samples E′, F′, G′, H′, I; and J) along with the second well of index pool column 412 (containing test samples B, H, N, I, Z, and F′) as being positive, then it could be determined that test sample F′ was the positive test sample, as it is the only test sample that is present in the test sample mixes from both pooled wells that tested positive.

When used in the matrix-type manner discussed in Use 2, and depicted in FIG. 4, the testing of any of the wells of index pool column 412, or any of trigger pool wells 414A, 416A, 414B, 416B, 414C, and 416C can provide a negative result for up to six of the test samples.

Insert 413 may allow for the moving index pool column 412 to and from organizing racks 400A, 400B, and 400C, as needed to easily facilitate the addition of test samples from the test sample columns 408A, 408B, and 408C and 410A, 410B, and 410C of organizing racks 400A, 400B, and 400C thereto.

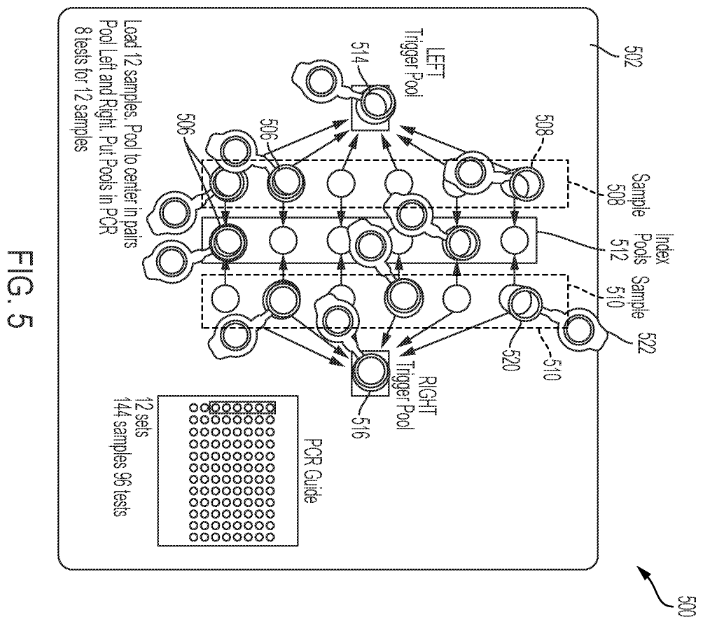

FIG. 5 shows an alternate embodiment of an organizing rack, specifically, organizing rack 500, which comprises wells 506 configured to receive and retain PCR-type tubes, such as tube 520. In embodiments, PCR tubes, such as tube 520, may comprise caps, such as cap 522, for sealing test samples, and/or mixes of test samples, inside of such PCR-type tubes, and for preventing contamination of such test samples and/or mixes of test samples retained inside of such PCR-type tubes.

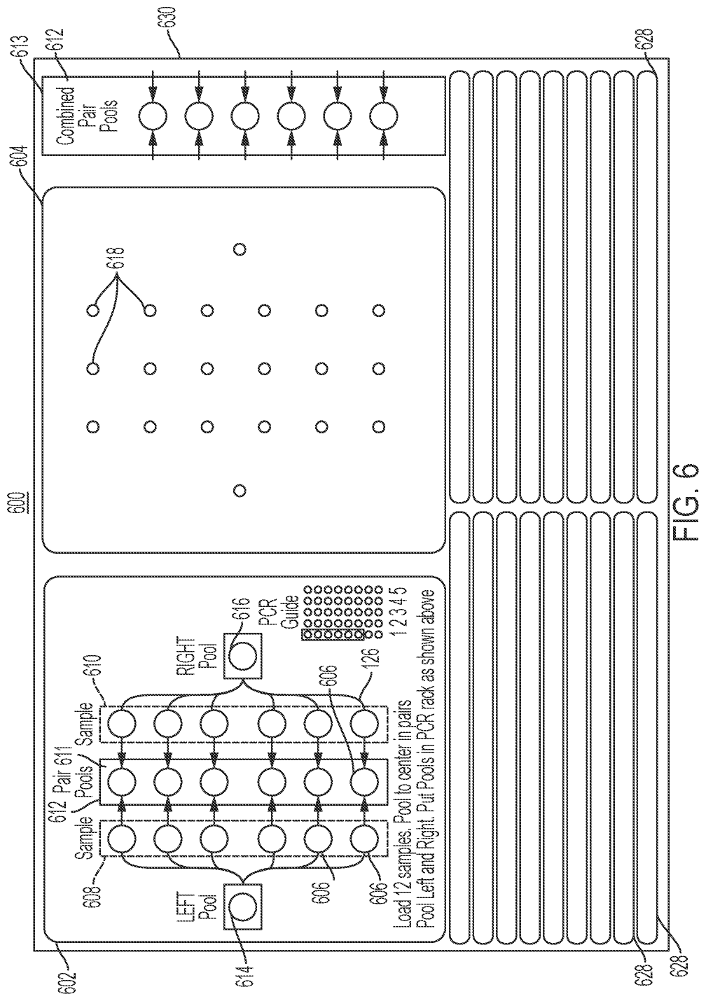

FIG. 6 shows an exemplary embodiment of an organizing rack kit, specifically kit 600. Kit 600 may consist of a sheet 630 of material with a plurality of partially cut-out components, which may be punched out of sheet 630 and assembled in order to form an organizing rack. Sheet 630 may comprise a cutout of organizing rack top surface 602, a cutout of organizing rack bottom surface 604, and a plurality cutouts of organizing rack lateral surfaces 628. Top surface 602 may comprise a plurality of wells 606, which may be organized into three columns, test sample column 608, test sample column 610, and index pool column 612, each of columns 608, 610, and 612 comprising a line of wells, and two trigger pool wells 614 and 616. Bottom surface 604 may comprise a plurality of holes 618, wherein each of the plurality of holes 618 may be positioned in a location corresponding a well 606 in top surface 612.

In embodiments, wells 606 may comprise apertures cut into top surface 602. In alternate embodiments, the apertures of wells 606 may not be fully cut-out of sheet 630; instead, being cut-into the top surface 602 portion of sheet 630 such that they may be easily punched out by a user when assembling an organizing rack from kit 600.

In embodiments, the diameter of each of the plurality of holes 618 in bottom surface 604 may be smaller than a diameter of its corresponding well 606 in top surface 602

In embodiments, each of the plurality of holes 618 may be in fluid communication with its corresponding well 606 in top surface 602.

In embodiments, sheet 630 may additionally comprises a cutout of insert 613 comprising index pool column 612, and top surface 602 may comprise slot 611, which may be configured to removably retain insert 613.

In embodiments, the components of the organizing rack formed from sheet 630 may comprise means for two or more lateral surfaces 628 to connect to and extend between to top surface 602 and bottom surface 604 such that top surface 602 and bottom surface 604 are positioned substantially parallel to one another when an organizing rack is assembled from the components of kit 600. Such means for connecting lateral surfaces 628 with top surface 602 and/or bottom surface 604 may comprise slot-and-tab type connectors, or any other suitable means known in the art, although slot-and-tab type connectors may be a preferred embodiment due to their simple geometry and ease of assembly. In embodiments, an edge of a component may operate as a tab for a slot-and-tab type connection between components of kit 600.

In embodiments, sheet 630 may comprise a rigid material, such as, for example, wood, plastic, metal, acrylic, or glass.

In embodiments, the components of an organizing rack formed from kit 600 may not initially be entirely separated from the rest of sheet 630. Said components may be connected to sheet 630 by one or more thin pieces of sheet material so that kit 600 may remain a single, flat, piece of material, with all components of the organizing rack arranged in a coplanar manner, until an end user completes the separation of the organizing rack components from sheet 630, such as by cutting any remaining pieces of sheet material connecting the components to sheet 630, or by punching the components out of sheet 630.

In embodiments, the cuts made into sheet 630 defining the separate organizing rack components formed therefrom may not extend through the entire thickness of sheet 630 but may be configured to enable easy separation of the components from sheet 630 along such partial cuts. In alternate embodiments, the cuts made into sheet 630 may comprise perforations of sheet 630.

Embodiments of kit 600 may be produced by suitable means known in the art, including through the use of a laser cutting machine, a plasma cutting machine, a waterjet, and a CNC machine.

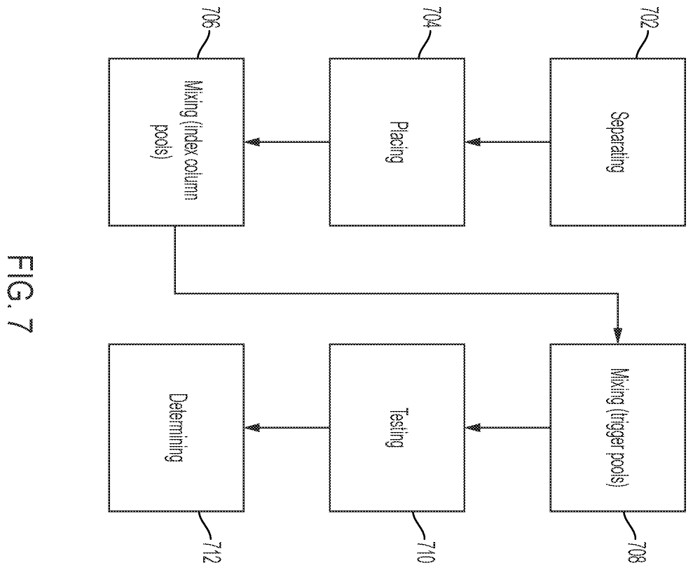

FIG. 7 shows block flow diagram showing an exemplary embodiment of a method for pooled testing using an organizing rack, such as organizing rack 100, namely method 700. The process of method 700 may begin by a user dividing 702 a plurality of test samples into a first test group consisting of a plurality of first test group samples and a second test group consisting of a plurality of second test group samples. The user may then continue by placing 704 each of the first test group samples in a separate first test sample column well and each of the second test group samples in its own second test sample column well. Once the first and second test sample columns have been filled with their respective groups of test samples, the step of mixing 706 a portion of a n^{th} first test group sample from a n^{th} first test sample column well with a portion of a n^{th} second test group sample from a n^{th} second test sample column well, in a n^{th} index column well, and repeating as necessary until each of the plurality of first test group samples and second test group samples have been mixed in this manner may be performed. After which, the step of mixing 708 a portion of each of the first test group samples in the first trigger pool well and a portion of each of the second test group samples in the second trigger pool well may occur. Once both trigger pool wells and all relevant index column wells have received their respective mixes of test samples testing 710 contents of the first trigger pool, the second trigger pool, and each of the plurality of index pool wells may be performed. After the experimental test results have been returned, then based on those results the step of determining 712 which test samples are positive based on the results of the testing of the mixed samples from the trigger pool wells and from the index pool wells may be performed.

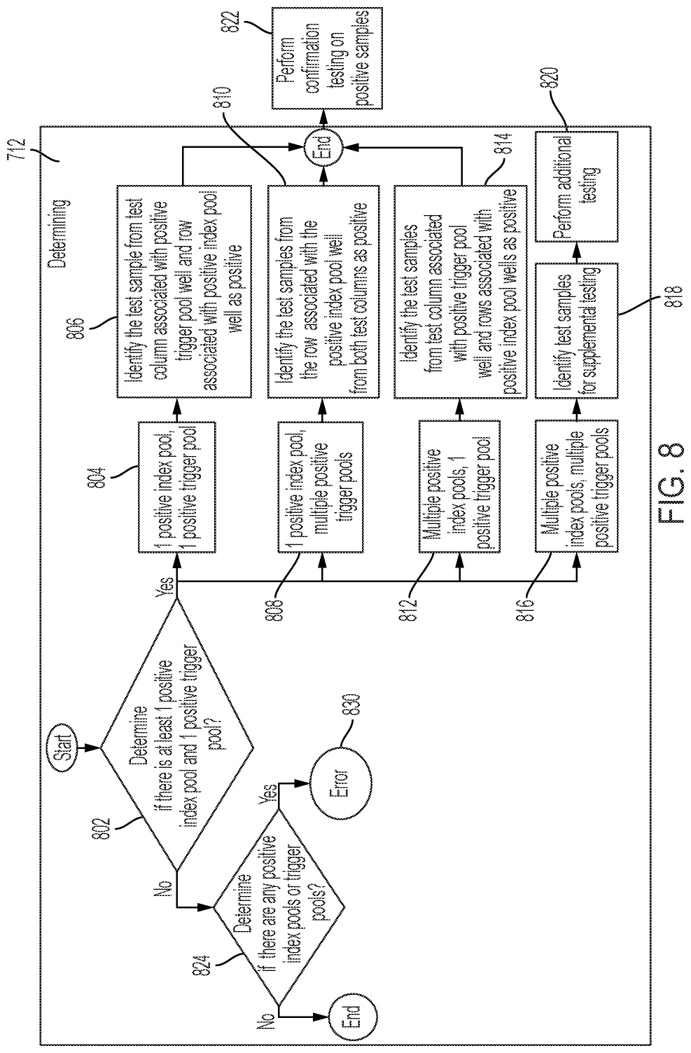

FIG. 8 shows a flowchart depicting an exemplary embodiment of the determining step 712 of method 700 from FIG. 7.

In accordance with embodiments determining 712 may comprise the steps of determining 802 if there is at least one positive result obtained from the mixture of test samples from an index pool well. If determining 802 is positive then depending on whether a single or multiple index pool wells that tests positive and whether a single or multiple trigger pool wells that test positive then the method may proceed to one of identifying steps 806, 810, 814, or 818. If a single index pool well and a single trigger pool well test positive, then the next step would be identifying 806 the test sample from the test sample column well associated with both the positive trigger pool well and the positive index pool well as positive. If a single index pool well and multiple trigger pool wells test positive, then the next step would be identifying 810 the test samples from each of the index pool wells that correspond with both the row of the positive index pool well and with each of the test sample columns associated with the positive trigger pool wells as positive. If multiple index pool wells test positive and a single trigger pool well tests positive, then the next step would be identifying 814 the test samples from the wells of the test sample column associated with the positive trigger pool well and corresponding to each of the rows containing positive index pool wells as being positive. If multiple index pool wells and multiple trigger pool wells test positive, then the next step would be identifying 818 test samples that would require supplemental testing, and then to perform 820 such additional testing.

Once determining 712 is completed and one or more test samples have been identified as having tested positive, as in steps 806, 810, and 814, any positive test samples so identified may be confirmed via additional testing 822 of the positive samples.

The method flow depicted in FIG. 8 may be a preferred embodiment of such determining step 712 as, due to the multi-hour time period required to complete PCR testing and PCR testing machines capability to test multiple samples at the same time, it is probable that all pooled samples would be tested simultaneously rather than in sequence.

In embodiments, the determining step 802 may be divided into separate steps where the test sample mixtures from the trigger pool wells, or a mixture containing all of the test samples (i.e., a master test sample mixture), may be tested first. If the master test sample mixture or none of test sample mixtures from the trigger pool wells test positive, they one may extrapolate that none of the test samples are positive with a minimum number of tests being performed. If the master test sample mixture or at least one of the sample mixtures from the trigger pool wells tests positive, then the test sample mixes from each of the wells of the index pool column may be tested subsequently. While potentially providing the benefit of screening all test samples with a minimum number of tests being performed, this sequential method of testing may not be practically ideal due to the length of time required to complete PCR testing.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

The detailed embodiments described herein are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A rack for organizing pooled testing of test samples, said rack comprising:
a first plurality of wells forming a first test column;
a second plurality of wells forming a second test column;
a third plurality of wells forming an index pool column;
a first pool well; and
a second pool well;
wherein the first and second test columns are located on opposite sides of the index pool column,
wherein the first pool well is located on a side of the first test column opposite the index pool column, and the second pool well is located on a side of the second test column opposite the index pool column; and
wherein the number of wells in the first, second, and third plurality of wells are equal.

2. The rack of claim 1, wherein the first, second, and third plurality of wells are positioned such that they form a plurality of rows of wells extending across the first test, index pool, and second test columns.

3. The rack of claim 1, further comprising:
an insert comprising third plurality of wells forming the index pool column; and
a slot configured to releasably receive the insert, located in between the first test column and the second test column

4. The rack of claim 1, wherein every well is configured to receive and retain a liquid.

5. The rack of claim 1, wherein every well is configured to receive and retain a PCR tube.

6. The rack of claim 1, further comprising:
a marking that groups together the third plurality of wells;
a marking indicating that the first test column and the second test column are for test samples; and
a marking indicating that the first pool well and the second pool well as being for trigger pool wells.

7. The rack of claim 1, further comprising:
a plurality of connector markings connecting each of a n^{th} first test column well and a n^{th} second test column well to a n^{th} index pool column well, each of said plurality of connector markings configured to indicate directionality, wherein said directionality is indicated as being towards the respective index pool column wells;
a first connector marking connecting the first pool well to the first test column; and
a second connector marking connecting the second pool well to the second test column.

8. The rack of claim 1, wherein each of the first, second, and third plurality of wells each comprise six wells.

9. The rack of claim 1, further comprising a bottom surface comprising a plurality of holes, wherein each of the plurality of holes is in a location corresponding a well, wherein a diameter of each of the plurality of holes is smaller than a diameter of its corresponding well, and wherein each of the plurality of holes is in fluid communication with its corresponding well.

10. A method for pooled testing using an organizing rack comprising: a first trigger pool well, a first sample column comprising a plurality of first sample column wells, an index pool column comprising a plurality of index pool column wells, a second sample column comprising a plurality of second sample column wells, and a second trigger pool well, wherein the number of first sample wells, index pool column wells, and second sample column wells are equal, the method comprising:
10.1. dividing a plurality of test samples into a first test group consisting of a plurality of first test group samples and a second test group consisting of a plurality of second test group samples;
10.2. placing each of the first test group samples in it's a separate sample column well and each of the second test group samples in its own second sample column well;
10.3. mixing a portion of a n^{th} first test group sample from a n^{th} first sample column well with a portion of a n^{th} second test group sample from a n^{th} second sample column well, in a n^{th} index column well, and repeating as necessary until each of the plurality of first test group samples and second test group samples have been mixed in this manner;
10.4. mixing a portion of each of the first test group samples in the first trigger pool well and a portion of each of the second test group samples in the second trigger pool well;
10.5. testing contents of the first trigger pool, the second trigger pool, and each of the plurality of index pool wells;
10.6. determining a positive test sample based on a result of the testing in step 10.5.

11. The method of claim 10, wherein the determining step 10.6 comprises:
10.6.1. determining if a mix of the first test group samples from the first trigger pool well is positive;
10.6.2. determining if a mix of the second test group samples from the second trigger pool well is positive;
10.6.3. determining if a mixture of first and second test group samples from each of the plurality of index pool column wells is positive;
10.6.4. identifying an index pool column well containing a mixture of first and second test group samples determined to be positive in determining step 10.6.3; and
10.6.5. performing one of the steps selected from the group consisting of:
10.6.5.1. determining that none of the plurality of test samples are positive responsive to a negative determination in determining steps 10.6.1 and 10.6.2;
10.6.5.2. determining that a first test group sample in a first test column well corresponding to the index pool column well identified in identifying step 10.6.4 is positive, responsive to a positive determination in determining steps 10.6.1 and 10.6.3, and a negative determination in determining step 10.6.2;
10.6.5.3. determining that a second test group sample in a second test column well corresponding to the index pool column well identified in identifying step 10.6.4 is positive, responsive to a positive determination in determining steps 10.6.2 and 10.6.3, and a negative determination in determining step 10.6.1; and
10.6.5.4. determining that further testing is required responsive to a positive determination in determining steps 10.6.1, 10.6.2, and 10.6.3.

12. An organizing rack kit comprising:
a sheet comprising a plurality of cuts;
wherein an organizing rack top surface is formed in a first portion of the sheet,
wherein an organizing rack bottom surface is formed in a second portion of the sheet, and
wherein a plurality of organizing rack lateral surfaces are formed in a third portion of the sheet.

13. The kit of claim 12, wherein the organizing rack top surface comprises a slot, and wherein an index pool column sized to be removably retainable within the slot is cut into a fourth portion of the sheet.

14. The kit of claim 12, wherein the sheet is comprised primarily of least one of:
plastic;
metal;
acrylic; and
glass.

15. The kit of claim 12, wherein the plurality of cuts are formed by a laser.

16. The kit of claim 12, wherein the plurality of cuts are formed by a waterjet.

17. The kit of claim 12, wherein the plurality of cuts are formed by a CNC machine.

18. The kit of claim 12,
wherein a reverse side of the organizing rack top surface comprises a first slot running substantially along a first edge of the reverse side of the organizing rack top surface and a second slot running substantially along a second edge of the reverse side of the organizing rack top surface, wherein the first edge of the reverse side of the organizing rack top surface and the second edge of the reverse side of the organizing rack top surface are opposite one another,
wherein a reverse side of the organizing rack bottom surface comprises a third slot running substantially along a first edge of the reverse side of the organizing rack bottom surface and a fourth slot running substantially along a second edge of the reverse side of the organizing rack bottom surface; and
wherein the first and third slots, and second and fourth slots align when the organizing rack top surface is stacked on the organizing rack bottom surface with the reverse side of the organizing rack top surface facing the reverse side of the organizing rack bottom surface.

19. The kit of claim 18, wherein the first and third slots are configured to receive and retain opposite edges of a first organizing rack lateral surface, and wherein the second and fourth slots are configured to receive and retain opposite edges of a second organizing rack lateral surface, such that the organizing rack top surface and organizing rack bottom surface are held substantially parallel to one another.

20. The kit of claim 12, wherein at least a first and second of the plurality of organizing rack lateral surfaces comprise a pair of slots spaced apart from, and running substantially parallel to, each other, wherein each of the pair of slots configured to receive and retain an edge of one of the organizing rack top surface and the organizing rack bottom surface while the organizing rack top surface and organizing rack bottom surface are positioned substantially parallel to one another.
